(19) United States
(12) Patent Application Publication
(10) Pub. No.: US 2014/0374625 A1
(43) Pub. Date: Dec. 25, 2014

(54) EUV DISCHARGE LAMP WITH MOVING PROTECTIVE COMPONENT

(71) Applicants: FRAUNHOFER-GESELLSCHAFT ZUR FOERDERUNG DER ANGEWANDTEN FORSCHUNG E.V., Muenchen (DE); USHIO DENKI KABUSHIKI KAISHA, Tokyo (JP)

(72) Inventors: JEROEN JONKERS, Berlin (DE); RALF PRUEMMER, Geilenkirchen (DE)

(21) Appl. No.: 14/303,649

(22) Filed: Jun. 13, 2014

(30) Foreign Application Priority Data
Jun. 21, 2013 (EP) 13003177.6

(51) Int. Cl. H05G 2/00; G21K 5/02; G21F 3/00

(52) U.S. Cl. CPC H05G 2/005; G21F 3/00; G21K 5/02; H05G 2/008
USPC 250/504 R; 250/515.1

(57) ABSTRACT

The present invention relates to an apparatus for generating EUV radiation and/or soft X-rays by means of an electrically operated discharge, in which a metal or metal melt is provided on a surface close to a discharge gap and evaporated by an energy beam, thereby generating a gaseous medium for ignition of a plasma. A protective component is arranged and shaped to cover at least one slit between parts of different electrical potential during operation. The protective component is moved during operation of the apparatus. Due to this movement the local heat load on the protective component is reduced.

### TECHNICAL FIELD

The present invention relates to an apparatus for generating EUV radiation and/or soft X-rays by means of an electrically operated discharge, said apparatus comprising a protective component arranged and shaped to prevent at least a direct passage of metal vapor or metal droplets from the discharge gap into slits between parts of the apparatus having different electrical potential. The invention also relates to a method of reducing a local heating of the protective component.

### BACKGROUND OF THE INVENTION

Plasma discharge lamps for generating EUV radiation (EUV: extreme ultraviolet) or soft X-rays, i.e. radiation in the wavelength region of around 1 nm to 20 nm, are required in the field of EUV lithography, microscopy or metrology.

Such a discharge lamp is disclosed for example in WO 2005/025280 A2. The EUV lamp of this document comprises two electrode wheels arranged in a discharge space at a distance from one another to form a gap which allows the ignition of plasma in a gaseous medium between the electrodes, as can be seen in FIG. 1. The electrode wheels 1 are rotatably mounted and partially dip into temperature controlled baths 2 comprising a liquid metal, for example tin. The material of the electrode wheels 1 allows the wetting of the electrodes by liquid tin, i.e. the surface of the electrode wheels 1 is covered with a thin layer of tin when rotating around rotation axis 3 through the tin baths 2. With a pulsed laser 4, tin is evaporated from one of the electrode wheels in the gap. The vapor cloud expands towards the second electrode wheel and after a certain time a short circuit is created between the electrode wheels. The capacitor bank 5, which is connected through an isolated feed through 6 to the tin baths 2, and therefore also to the electrode wheels 1, discharges and a hot plasma is created which emits the desired EUV radiation. The whole arrangement is situated in a vacuum vessel 8 which reaches at least a basic vacuum of 10⁻⁴ hPa. The tin layer 7 on the surface of the electrode wheels 1 is controlled in thickness by skimmers 9. The thickness is controlled to be typically in the range between 0.5 μm and 500 μm. Optical elements like mirrors outside the lamp are protected by a debris mitigation unit 11 which is arranged at the emissive side of the lamp. Such a debris mitigation unit 11 allows the path of the radiation and suppresses the path of the metal vapor. The figure also schematically shows two heater/cooling units 12 for maintaining the metal melt in the baths 2 at a preset temperature.

In order to avoid transport of evaporated tin or tin droplets to other parts of the lamp, a protective metal shield 10 is arranged inside the lamp below the discharge gap. This so called wedge is crucial for a high conversion efficiency as well as a long life time of the lamp. A high conversion efficiency requires the inductivity of the electrode system to be low, i.e. <10 nH, which means that the gaps or slits between the parts at different electrical potential should be small, in particular of the order of several millimeters. Those small gaps can be easily bridged by some tin that accumulates over the life time of the lamp head. If this happens, effectively a short circuit is made so that the capacitor bank can not be charged again and no EUV can be generated. For the repair action, the lamp head needs to be replaced and thus at least the vacuum needs to be broken, which results in significant down time of the discharge lamp. To avoid that tin splashes into the crucial slit the metal shield 10, a special roof above the slit, is provided in the lamp of FIG. 1. This metal shield covers the slits between the two tin baths 2 and a metallic element which are of different electrical potential during operation of the lamp.

WO 2005/025280 A2 also discloses an embodiment of a plasma discharge lamp in which the metal shield is formed as a rotating disk used for transporting the liquid metal close to the discharge gap. This rotating disk dips into a reservoir with the liquid tin during rotation. This restricts the shape of this shield so that it can not cover the slits to be effectively protected from liquid metal vapor or drops.

The metal shield, in the present patent application also called protective component, must be located close to the plasma discharge, the distance varying from a few millimeters to a few centimeters, so that it is exposed to high average light intensity emitted by the plasma. When the average input power of the lamp or apparatus is scaled up the protective component could become too hot resulting in the following problems. The tin that is deposited on this protective component then evaporates to a high degree and can have a negative impact on the plasma generating the EUV. Also at such higher temperatures, the material of the protective component will react much faster with the tin so that the protective component will be corroded away.

### DESCRIPTION OF THE INVENTION

It is thus an object of the present invention to provide an apparatus for generating EUV radiation and/or soft X-rays by means of an electrically operated discharge in which the heating effect on the protective component is reduced. It is also an object of the present invention to provide a method for reducing the temperature of the protective component in such an apparatus.

The object is achieved with the apparatus and method according to claims 1 and 14. Advantageous embodiments of the apparatus and method are subject matter of the dependent claims or are disclosed in the subsequent portions of the description.

The proposed apparatus for generating EUV radiation and/or soft X-rays by means of an electrically operated discharge at least comprises

two electrodes arranged at a distance from one another to form a discharge gap which allows ignition of a plasma in a gaseous medium between said electrodes,

a device for providing a metal or metal melt on a surface at the discharge gap,

an energy beam device adapted to direct an energy beam onto said surface evaporating said metal or metal melt at least partially thereby generating at least part of said gaseous medium, and

a protective component arranged and shaped to prevent at least a direct passage of metal vapor or metal droplets generated by evaporating said metal or metal melt into at least one slit between parts of the apparatus having different electrical potential during operation, said parts being covered at least partly by the protective component. In the proposed apparatus the protective component is mounted allowing to be placed in movement, in particular in rotation, during operation of the apparatus.

With such a movement of the protective component, i.e. the protective shield or wedge, the heat on the protective component is distributed over a larger surface area during operation. Therefore, the local heating of the protective component is lowered compared to a static component. On the other hand, the protective component may be appropriately shaped to sufficiently cover the one or several slits between components of different electrical potential during operation and thus provides an effective protection against the deposition of liquid metal in such slits. Also additional static shields or wedges can be used to shield the slits for droplets reflected via other surfaces, i.e. there will be no direct line-of-sight from the discharge, so the heating of these additional parts will be much smaller.

The proposed method of reducing the heating effects on the protective component in such an apparatus accordingly comprises a movement, preferably a rotation, of this protective component during operation of the apparatus. The movement or rotational speed may be selected dependent on the heat load on the protective component.

The proposed apparatus is preferably designed like the discharge lamp known from WO 2005/025280 A2. Therefore, the electrodes are formed by electrode wheels placed in rotation during operation of the apparatus and dipping into containers with the metal melt while rotating. The electrodes are electrically connected to a capacitor bank via the metal melt. The metal melt is thus applied to the outer surfaces of the rotating electrodes and conveyed with the rotation to the discharge gap. The proposed device for providing a metal melt on a surface at the discharge gap is thus formed by the two containers with the liquid metal melt and the corresponding driving arrangement of the electrodes. Instead of the containers also other types of devices may be provided, which apply the liquid metal to the outer surface of the rotating electrodes. An energy beam, preferably a laser beam, is focused onto the surface of at least one of the electrodes at the discharge gap to evaporate the liquid metal, preferably liquid tin, for generating at least part of the gaseous medium. The operation of such an apparatus is explained in detail in the above mentioned WO 2005/025280 A2. In order to avoid the deposition of the liquid metal in the gap or slit between the two containers having a different electrical potential, the protective component is arranged between the discharge gap and the to be protected gap or slit and shaped to cover the complete gap or slit. The term “cover” in this context means that the gap or slit is masked by the protective component in a region of a parallel projection of the protective component in the direction from the discharge to the gap or slit.

In a preferred embodiment, the rotational axis of the protective component is arranged which respect to the electrodes such that the protective component and/or its driving axis can extend without any restriction by the electrodes so that the required length of the protective component in this direction and the connection of the driving axis with a driving motor can be easily realized.

Nevertheless, the proposed apparatus may also be designed differently from the above preferred design. The metal or metal melt may also be provided on another surface close to the discharge gap, from which surface the metal or metal melt is then evaporated. The provision of the metal or metal melt may thus be realized not only by means of the electrodes itself but also by other transporting means, for example by a transporting belt or by an appropriately arranged nozzle. It is also possible to provide the metal in a solid form which is then melted by the energy beam and evaporated. The electrodes itself may also be formed in a different manner. It is obvious to the skilled person that with such other designs of the apparatus the proposed movement or rotation of the protective component fulfills the same task, i.e. protects any slit or gap between parts of different electrical potential against deposition of the metal while reducing the local heat load of this protective component.

The proposed protective component preferably has a rotation-symmetric elongated shape, i.e. the cross section perpendicular to the rotational axis is circular. The diameter of the protective component may however vary along the rotational axis which allows an effective protection of the gaps or slits arranged underneath the protective component.

The protective component may additionally be mounted on a rotational driving axis that allows an oscillation or movement of the component along this axis. Such an oscillation further increases the area of heat deposition and thus further reduces the local heat load of the protective component during operation of the apparatus.

In a preferred embodiment the protective component may additionally be cooled by integrating at least one cooling channel in the component. The cooling channel is connected to a cooling circuit which allows the flow of a cooling liquid through the cooling channel during operation of the apparatus. With this additional forced cooling the temperature of the protective component can be controlled. The protective component can for example be cooled with water as the cooling liquid. The cooling with water can be implemented very easy but requires special precautions. The water cooling can freeze the liquid metal at low power and on the other hand can easily boil if the power dissipation in the protective component becomes high. Therefore, instead of water cooling preferably a liquid metal, in particular the liquid metal used for generation of the gaseous medium, is used as the cooling liquid. Although a separate circuit for this liquid metal may be required for such a solution, it does not have the disadvantages of water cooling.

In order to prevent liquid metal deposited on the protective component to uncontrolled fly off during rotation of the component, a droplet catcher or a skimmer may be arranged on the side of the protective component to which the surface of this component after passing the pinch region of the discharge moves first. The droplet catcher is an element arranged and shaped such that droplets flying off the rotating protective component deposit on this element and are safely guided with this element to a corresponding reservoir, for example to the container containing the liquid metal for the gas discharge. This droplet catcher may for example have a concave surface on the side of the protective component, in particular a spherical or near spherical cross section. The droplet catcher avoids a deflection of impinging droplets towards positions where the liquid metal will cause problems. Additionally or instead of the droplet catcher at least one skimmer may be provided to remove an excess of the liquid metal on the rotating protective component and to guide this excess metal to the corresponding surface of the droplet catcher or to a corresponding reservoir.

With the proposed apparatus and corresponding method the local temperature or heat load of the protective component is reduced compared to other known arrangements and shapes of such a component. If the surface of the protective component is kept only slightly above the melting point temperature of the metal, the metal will evaporate only very slowly and will thus not have a negative impact on the EUV or soft X-ray generation. Also the reaction speed of the liquid metal with the material of the protective component will be much slower at such a temperature.

### SHORT DESCRIPTION OF THE DRAWINGS

The proposed apparatus and method will be described in the following by way of examples in connection with the accompanying figures. The figures show:

FIG. 1 a cross sectional view of an apparatus for generating EUV radiation and/or soft X-rays according to the prior art;

FIG. 2 a cross sectional view of an exemplary embodiment of the proposed apparatus;

FIG. 3 a perspective view of a cut portion of the proposed apparatus according to an exemplary embodiment;

FIG. 4 a cross sectional view of a further exemplary embodiment of the proposed apparatus;

FIG. 5 a schematical cross sectional view showing an oscillatory movement of the protective component along the rotational axis; and

FIG. 6 a schematical cross sectional view showing the arrangement and exemplary shape of a droplet catcher in the proposed apparatus.

### DESCRIPTION OF EMBODIMENTS

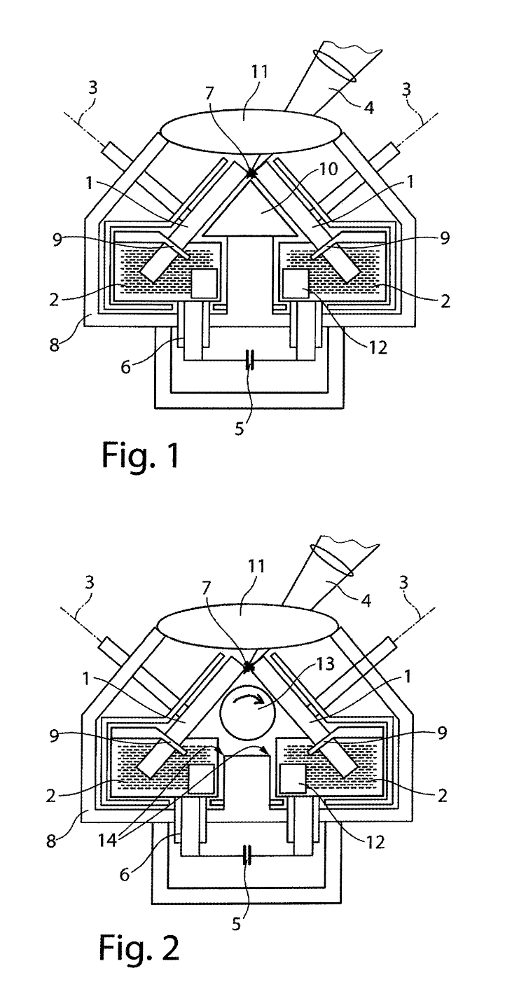

The EUV plasma discharge lamp of FIG. 1 has already been described in the introductory portion of the present description. In the following example an embodiment of the design of the protective shield, i.e. the protective component of the proposed apparatus is described, which can be used to substitute the metal shield 10 of FIG. 1. The further components of the proposed apparatus can be identical to this known lamp so that these components are not further explained in connection with the following example.

FIG. 2 shows a cross sectional view of such an embodiment of the proposed apparatus. In this apparatus the metal shield 10 of FIG. 1 is substituted by the rotating protective component 13 as shown in FIG. 2. This protective component 13 may be formed from a metal and is mounted such that it can rotate in the indicated direction during operation of the discharge lamp. In the present embodiment, this protective element 13 has an elongated shape extending in the direction of the rotational axis, i.e. perpendicular to the cross section as shown in FIG. 2. The protective component 13 has a circular cross sectional shape with a diameter large enough to cover the slits 14 between the two tin baths 2 and the wall of the vacuum vessel 8 shown in the figure. The protective component is thus formed like a third wheel, in addition to the two electrode wheels, and is acting as a roof to protect the crucial gap or slit 14. Due to the elongated shape, in particular in form of a rotating bar, this protective component 13 covers the critical part of the slit 14 when looking from the position where droplets of liquid metal are produced.

The driving axis of the protective component can be extended outside of the vacuum vessel 8 in the same manner as the driving axis 3 of the electrode wheels. The protective component can thus be driven in the same manner as the electrode wheels by an appropriate motor.

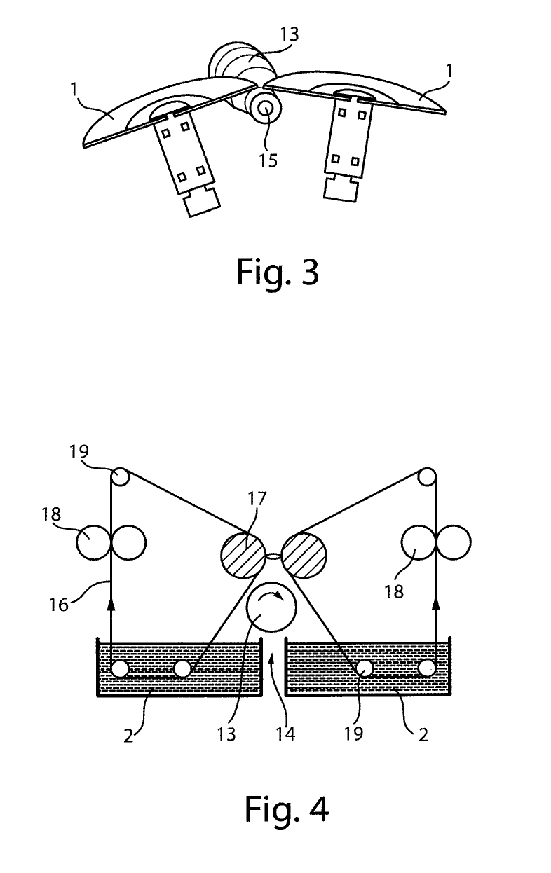

The diameter of the protective component can vary along the rotational axis as shown in the perspective view of FIG. 3. With such a variation in the shape also other hardware of the lamp head or apparatus can be better shielded against the heat load from the pinch discharge. FIG. 3 shows a cut-through perspective view in which the varying diameter of the protective element 13 can be recognized. The figure also shows part of the electrode wheels 1 as well as the driving axes of these electrode wheels. As can also be seen in FIG. 3, the rotating protective component 13 can be equipped with an internal cooling channel 15. Standard water cooling is one of the options. Preferably liquid tin is used as the cooling liquid which is also used for generating the gaseous medium for the discharge. The use of liquid tin or another liquid metal is preferred since these materials have a high cooling power and can guarantee that the rotating protective component 13 stays above the melting point of the fuel, so that accumulation is avoided. If necessary, also a metal alloy could be used to optimize the cooling range.

FIG. 4 shows another example of a realization of the proposed discharge lamp. In this example, the electrodes are formed by conveyer belts 16 which are guided through the tin baths 2. Shaper elements 17 are used as electrical contact between the capacitor bank and the conveyer belts 16. The shaper elements 17 rotate in this embodiment. Cooled rollers 18 are provided and used to cool the conveyer belts 16 below the melting point of tin. Having the conveyer belt 16 covered with solid tin has the advantage that much higher driving velocities for the belt can be obtained, without the risk that the tin is spinning off. The belt is guided by guide rollers 19 on its way through the tin baths 2 and outside the tin baths. In this embodiment, the protective element 13 is shaped and arranged similar as in the previous embodiment to cover the slit 14 between the two containers with liquid tin. This is schematically indicated in FIG. 4.

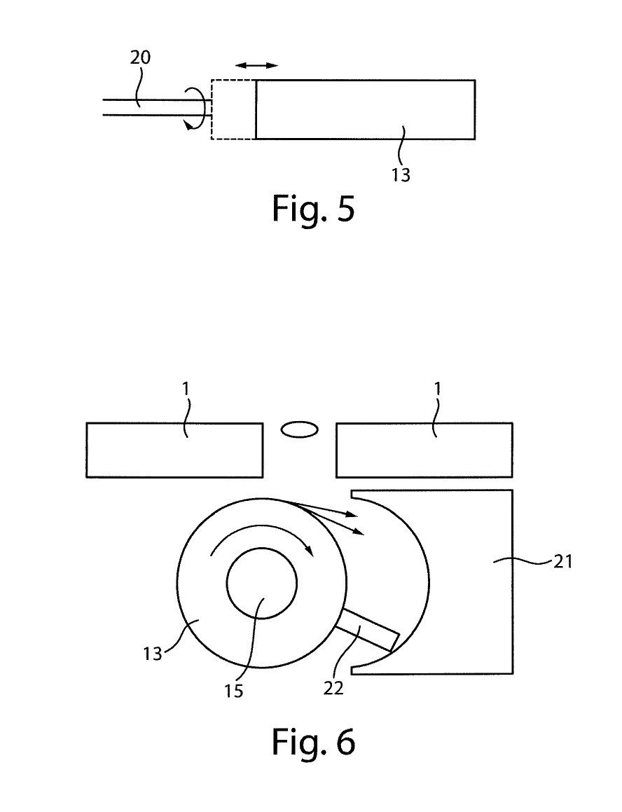

An extension of the idea to limit the damage due to erosion caused by the high temperature is to introduce an additional oscillation of the protective component 13 in the direction of the rotation axis. FIG. 5 shows a schematic view indicating such an oscillation along the rotation axis 20 with the depicted arrow. Due to this additional oscillation the hot spot is distributed over a larger area of the protective component.

The rotating protective component is placed in the region between the anode and cathode wheels in case of the embodiment of FIGS. 2 and 3 or generally between the two electrodes. During operation of the apparatus droplets of the liquid metal are generated during the discharge in the plasma and fly off from the rotating electrode wheels due to interaction between the liquid surface and the plasma and/or energy beam. Therefore, the protective component will be covered with liquid metal. Since the protective component is preferably slightly above the melting point of tin to avoid a large build up of solid tin, e.g. in the temperature range between the melting point of tin (232° C.) and a temperature of approx. 1000° C., liquid tin will also spin off at a certain moment, also in case the protective component is rotating. This tin has to be guided into a container or bucket since otherwise it will end up in the gap between the parts of different electric potential and then cause a short circuit between the electrodes.

In case of the rotating protective component, FIG. 6 shows an easy measure to avoid that the droplets enter in the gap between the above parts. Due to the rotation of the protective component the tin droplets will be reflected with a preferential direction as indicated with the two arrows in the figure. At this position a special droplet catcher 21 is installed, to avoid that these droplets reflect further into the apparatus. The droplets deposit on the concave surface of this droplet catcher and flow down into the corresponding container.

A further measure is also indicated in the figure. This measure includes a skimmer 22 that is removing the excess of tin from the protective component, so that the rotating protective component is covered only by a thin layer of tin. The skimmer 22 is arranged such that the liquid tin gathered by this skimmer flows to the inner surface of the droplet catcher 21 and from there into the corresponding container. The protective component 13 could rotate at a high rotation speed, e.g. above 20 m/s, such that the droplets fly off close to the point where they hit a sensitive component, i.e. the gap or the electrode wheels. These wheels 1 are located on the top part as shown in FIG. 6. The droplets will not reach the bottom part where the gap between the parts of anode and cathode potential is situated. The same measure can also be used to remove the tin from the electrode wheels.

While the invention has been illustrated and described in detail in the drawings and forgoing description, such illustration and description are to be considered illustrative or exemplary and not restrictive; the invention is not limited to the disclosed embodiments. Other variations of the disclosed embodiments can be understood and affected by those skilled in the art in practicing the claimed invention, from a study of the drawings, the disclosure, and the appended claims. For example, the protective component may also be a continuous belt which is rotated around several guide rolls. The movement of the protective component may also be a linear movement without rotation. In the claims the word “comprising” does not exclude other elements or steps and the indefinite article “a” or “an” does not exclude a plurality. The mere fact that certain measures are recited in mutually different dependent claims does not indicate that a combination of these measures can not be used to advantage. The reference signs in the claims should not be construed as limiting the scope.

### LIST OF REFERENCE NUMERALS

1 electrode wheel
2 tin baths
3 rotation axis of electrode wheels
4 energy beam
5 capacitor bank
6 isolated feed through
7 tin layer
8 vacuum vessel
9 skimmer
10 metal shield
11 debris mitigation unit
12 heater/cooling unit
13 protective component
14 slit
15 cooling channel
16 conveyer belt
17 shaper elements
18 cooled rollers
19 guide rollers
20 rotation axis of protective component
21 droplet catcher
22 skimmer

1. An apparatus for generating EUV radiation and/or soft X-rays by means of an electrically operated discharge, said apparatus at least comprising:
two electrodes arranged at a distance from one another to form a discharge gap which allows ignition of a plasma in a gaseous medium between said electrodes,
a device for providing a metal or metal melt on a surface at the discharge gap,
an energy beam device adapted to direct an energy beam onto said surface evaporating said metal or metal melt at least partially thereby generating at least part of said gaseous medium, and
a protective component arranged and shaped to prevent at least a direct passage of metal vapor or metal droplets generated by evaporating said metal or metal melt into at least one slit between parts having different electrical potential during operation and being covered at least partly by the protective component,
wherein the protective component is mounted allowing to be placed in movement during operation of the apparatus.

2. The apparatus according to claim 1,
wherein the protective component is mounted allowing to be placed in rotating movement during operation of the apparatus.

3. The apparatus according to claim 1,
wherein said device is adapted to provide said metal or metal melt on a surface of at least one of said electrodes.

4. The apparatus according to claim 3,
wherein said electrodes can be placed in rotation during operation of the apparatus.

5. The apparatus according to claim 4,
wherein said electrodes dip while rotating into containers containing said metal melt.

6. The apparatus according to claim 1,
wherein the protective component comprises at least one cooling channel.

7. The apparatus according to claim 6,
wherein the at least one cooling channel is connected to a cooling circuit conveying a cooling liquid through the cooling channel during operation of the apparatus.

8. The apparatus according to claim 7,
wherein the cooling circuit comprises a liquid metal, in particular the melted metal for generating at least part of said gaseous medium, as the cooling liquid.

9. The apparatus according to claim 1,
wherein the protective component has an elongated rotation-symmetric shape and is rotated around its rotational symmetry axis.

10. The apparatus according to claim 9,
wherein a diameter of the protective component varies along its rotational symmetry axis.

11. The apparatus according to claim 1,
wherein the protective component is mounted allowing to be placed in rotation during operation of the apparatus and to allow an oscillation of the protective component along its axis of rotation.

12. The apparatus according to claim 1,
wherein the protective component is mounted allowing to be placed in rotation during operation of the apparatus and a shield is arranged on one side of the protective component to catch droplets flying off the protective component due to the rotation.

13. The apparatus according to claim 1,
wherein the protective component is mounted allowing to be placed in rotation during operation of the apparatus and at least one skimmer is arranged at the protective component to strip off liquid metal from the protective component during rotation.

14. A method of reducing a heating effect on the protective component in an apparatus according to claim 1, wherein the protective component is moved during operation of the apparatus.

15. The method of claim 14, wherein the protective component is rotated during operation of the apparatus.

16. The method of claim 15, wherein the protective component is additionally oscillated along its axis of rotation during operation of the apparatus.
